(19) United States
(12) Patent Application Publication
(10) Pub. No.: US 2006/0078666 A1
(43) Pub. Date: Apr. 13, 2006

(54) Laminated coconut palm and products thereof

(76) Inventors: Daniel Gardiner Smith, San Francisco, CA (US); Wen-Huang Liu, Nan-Tou (TW)

Correspondence Address: STEVEN VOSEN, 1563 SOLANO AVENUE #206, BERKELEY, CA, 94707, US

(21) Appl. No.: 11/024,995

(22) Filed: Dec. 29, 2004

Related U.S. Application Data
(60) Provisional application No. 60/617,556, filed on Oct. 8, 2004.

(51) Int. Cl. A23D 7/00; A23D 9/00

(52) U.S. Cl. 426/603

(57) ABSTRACT

Methods and products are described having improved structural stability and which are particularly suitable for manufacture using coconut palm. Each product includes a core and a veneer laminated to form a product, and includes arrangements of the core pieces to provide improved structural stability. In one embodiment, elongated strips of palm having square cross-sections are laminated with parallel grains to form a core. In another embodiment, elongated strips of palm having rectangular cross-sections are laminated with parallel grains and with the long sides of the rectangles of adjoining strips abutting. A third embodiment of the present invention is a square flooring tile arranged from a plurality of core pieces arranged with the grain generally parallel to the edge of the core. The products can support a veneer or kerf as is suitable to particular uses.

### CROSS-REFERENCE TO RELATED APPLICATIONS

This application claims the benefit of U.S. Provisional Application No. 60/617,556, filed Oct. 8, 2004.

### FIELD OF THE INVENTION

The present invention relates to wood products and is directed to, in particular, wood products including, but not limited to, plywood-like products and flooring panels made from coconut palm material.

### BACKGROUND OF THE INVENTION

Hardwood has many aesthetic and structural qualities that make it particularly desirable for use in construction, for example in flooring and paneling, and in making furniture. Many types of hardwood are obtained from rainforests, where poor resource management often results in damage to the local environment. Since the need for hardwood is increasing worldwide, it would be desirable to obtain useful hardwood from these fragile environments in a fashion that does not harm the local environment.

Palms are a potentially large source of environmentally-produced hardwood. In particular, coconut palms (cocos nucifera) are widely grown in plantations in the tropics for their nuts, which are a valuable source of food and are used to produce manufactured goods. Thus, for example, the nut of the coconut palm produces a solid “meat” (copra) that can be pressed to form oil, and a “milk” that is edible. The nut can also be processed to produce products including soap, lubricants, explosives, margarine, and other goods. Coconut palms can be productively harvested for approximately 80 years, after which nut production decreases and the trees are removed and replaced with newer palms.

While a palm that no longer produces nuts can be harvested for its lumber, the structure and shape of palm lumber makes the ready incorporation of this material into structurally stable products difficult. In particular, there are several problems in manufacturing and using palm lumber products. Mature coconut palms have a diameter of 1 to 2 feet and are 50 to 80 feet tall. The density, and thus hardness, of palm increases gradually from the center to the outer edge, and thus is difficult to obtain large pieces of palm having a uniform hardness. Typically, it is not possible to obtain uniform strips of palm that are greater than about 3 inches wide. In addition, palm responds to changes in humidity by warping, and as a result large pieces of palm are not structurally stable. For these reasons, lumber products formed exclusively from palm are rarely used for construction or to provide lumber product surfaces, such as flooring or paneling.

### SUMMARY OF THE INVENTION

It is an aspect of the present invention to provide a lumber product that efficiently utilizes coconut palm and that has improved structural stability.

It is another aspect of the present invention to provide a coconut palm core and a plurality of additional palm pieces that are arranged to provide superior structural stability.

It is one aspect of the present invention to provide a core for a lumber product comprising a plurality of strips of coconut palm, where the strips have a rectangular cross-sectional shape and where adjoining strips of the product are arranged with abutting long sides of the rectangular shape.

It is another aspect of the present invention to provide a core for a lumber product comprising a plurality of strips of coconut palm, where the strips have a rectangular cross-sectional shape that is square.

It is one aspect of the present invention to provide a core for a substantially square lumber product comprising a plurality of pieces of coconut palm arranged with a central piece and a plurality of strips arranged with grains that are substantially parallel to the edge of the core.

It is another aspect of the present invention to provide a wood-like product including a core having a pair of opposing major surfaces including a first surface and a second surface, and a veneer of the first surface. The core includes a plurality of elongate strips of coconut palm each having a cross-section and grains aligned with the length of each strip. In one embodiment, the core is a single-ply core, and a second veneer is disposed on the second surface. In another embodiment, the core is a double-ply core. In yet another embodiment, the major pair of opposing surfaces is rectangular, and the sides of the core have matching tongue-and-groove structures to facilitate arrangement of a plurality of products on a planar surface.

It is yet another aspect of the present invention to provide a laminated wood-like product including a core and a veneer of coconut palm on opposing core major surfaces. The core includes a plurality of elongate strips of coconut palm each having a cross-section and having grains aligned with the length of the strip.

It is one aspect of the present invention to provide a wood-like product including a core having a pair of opposing major surfaces including a first surface and a second surface and a substantially square perimeter defining four edges. The core is a single-ply core including a plurality of elongate strips each having a cross-section, and the grain is parallel along at least one half of each of the four edges. The product also includes a veneer substantially covering one pair of the opposing surfaces. In one embodiment, the veneer is a parquet. In another embodiment, the edges include tongue-and-groove structures to facilitate their assembly on a planar surface.

These features together with the various ancillary provisions and features which will become apparent to those skilled in the art from the following detailed description, are attained by the exercise device of the present invention, preferred embodiments thereof being shown with reference to the accompanying drawings, by way of example only, wherein:

### BRIEF DESCRIPTION OF DRAWINGS

FIG. 1 is a perspective view showing the top and sides of a first embodiment of a laminated palm product of the present invention;

FIG. 2 is a sectional top view 2-2 showing a view of the core of the embodiment of FIG. 1;

FIG. 3 is a bottom view 3-3 showing a view of the first and second veneers the embodiment of FIG. 1;

FIG. 4 is a perspective view showing the top and sides of a second embodiment of the present invention showing palm flooring planks on a surface;

FIG. 5 is side view of one flooring plank of the embodiment of FIG. 4;

FIG. 6 is a top view 6-6 of the embodiment of FIG. 5;

FIG. 7 is a sectional top view 7-7 of the embodiment of FIG. 5 showing the core;

FIG. 8 is a bottom view 8-8 of the embodiment of FIG. 5;

FIG. 9 is a top view of a third embodiment of the present invention showing one parquet square;

FIG. 10 is a bottom view of the embodiment of FIG. 9;

FIG. 11 is a sectional side view 11-11 of FIG. 9;

FIG. 12 is a sectional top view 12-12 of FIG. 11;

FIG. 13 is a perspective view showing the top and sides of another laminated palm product of the present invention;

FIG. 14 is a sectional top view 14-14 showing a view of the core of the embodiment of FIG. 13; and

FIG. 15 is a bottom view 15-15 showing a view of the first and second veneers the embodiment of FIG. 13.

Reference symbols are used in the Figures to indicate certain components, aspects or features shown therein, with reference symbols common to more than one Figure indicating like components, aspects or features shown therein.

### DETAILED DESCRIPTION

The present invention includes, in general, lumber products described herein with reference to embodiment's manufactured using coconut palm, including, but are not limited to, planks or parquet squares for flooring, or finished plywood-like products. It is understood that the scope of the present invention includes products that include other materials or that are produced in other shapes or purposes, and that the various embodiments discussed herein are illustrative and are not meant to limit the scope of the present invention.

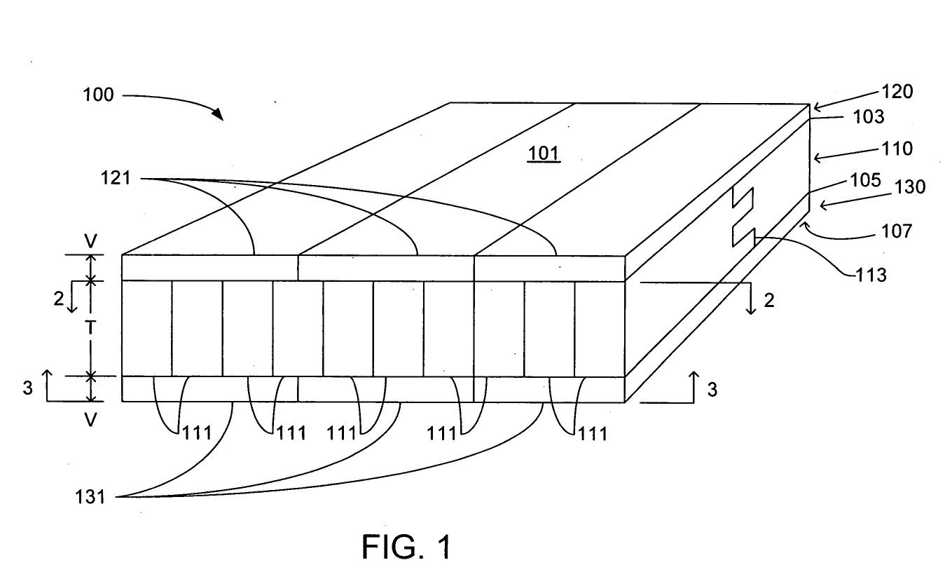

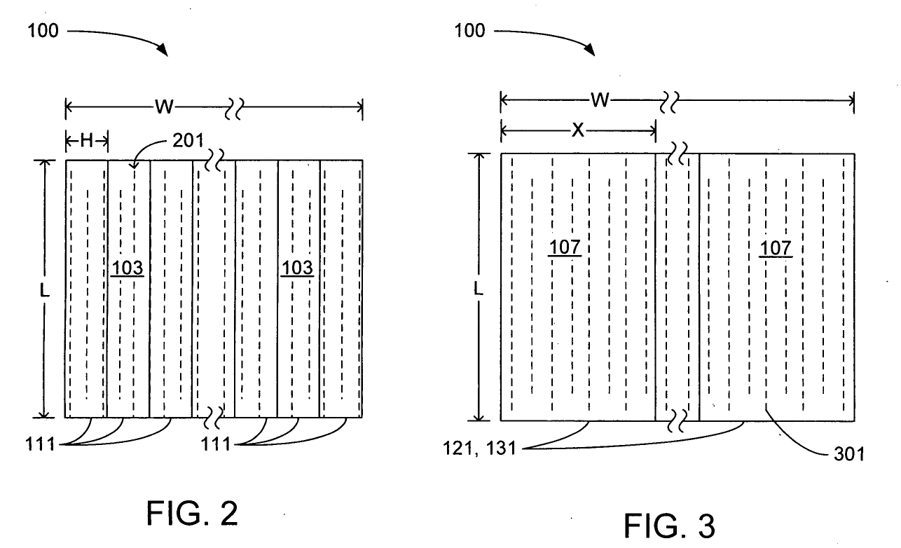

FIG. 1 is a perspective view showing the top and sides of a first embodiment of a laminated palm plywood 100 having a core 110, a first veneer 120, and a second veneer 130, FIG. 2 is a sectional top view 2-2 of the core of FIG. 1, and FIG. 3 is a bottom view 3-3 of the second veneer. As an example plywood 100 that is not meant to limit the scope of the present invention, the plywood is illustrated in FIGS. 1-3 as having a length L and a width W. Laminated palm 100 has a first surface 103 and a second surface 105, and is formed from a core 110 having a first side 103 and a second side 105, a first veneer 120 affixed to the first side to present finished surface 101, and a second veneer 130 affixed to the second core side 105 to present finished surface 107. As shown in FIG. 1, plywood 100 is a planar structure having thickness that includes a thickness T of core 110 and the thicknesses V of both the first and second veneers 120 and 130. Plywood 100 is formed by laminating the strips and veneers, for example, by a cold press lamination process.

As shown in FIGS. 1 and 2, core 110 includes a plurality of strips 111 each of length L. The plurality of strips 111 are arranged as a “single-ply core,” being substantially one strip deep through the thickness of core 100. Strips 111 are formed from a single piece of palm of length L, or optionally from two or more pieces of palm joined together to form an elongated strip of length L, for example using finger joints 113. Each strip 111 has a grain 210 aligned with the length L. It is preferred that the cross section of each strip 111 in a plane perpendicular to the direction of length L has a shape that is approximately rectangular, with each strip having a first dimension T through the thickness of plywood 100, as shown in FIG. 1, that is common to each strip, and a second dimension H in the plane of plywood 100, shown in FIG. 2 that is preferably, though not necessarily, the same for each of the plurality of strips. In the embodiment of FIG. 1, the thickness of the core is equal to one of the dimensions of the plurality of strips. The total width W of core 110 is the sum of the widths H of individual ones of the plurality of strips 111. The plurality of strips 111 are laminated with parallel grain, forming a laminated palm or lumber core 110.

In a particularly preferred embodiment, each of the plurality of strips 111 has a rectangular cross-sectional shape that is either square, or that is oriented with the long dimension equal to the thickness T of core 110. Thus in the embodiment of FIG. 1, the cross-sectional shape is rectangular with the long dimension through the thickness, i.e., the width T is greater than the height H. In an alternative embodiment, the cross-sectional shape is square, i.e., the width T is equal to the height H. The arrangement of strips in the present invention provides for greater structural stability than the prior art.

In one embodiment of the present invention, the combined thickness (T+2V) is approximately three-quarters of an inch. The length L and width W can be of a size useful as plywood. Thus, as one example of plywood 100 that is not meant to limit the scope of the present invention, the dimension L is from 6 inches to 24 inches, and preferably 9 inches. In another non-limiting embodiment of the present invention, the dimension L is from 30 inches to 48 inches, and the dimension W is from 72 inches to 96 inches.

As shown in FIGS. 1 and 3, first veneer 120 and second veneer 130 are similar and are formed from a plurality of similarly shaped veneers strips 121 and 131, respectively. Veneers 120 and 130 have grains 301, indicated by dashed lines, aligned with length L, and have cross-sectional shape that is preferably rectangular, with thickness V and a width X. It is preferred that grains 301 are parallel to grains 201. In an alternative embodiment, the first and second veneers are formed of individual veneers of different sizes.

Plywood 100 is preferably manufactured using strips having small dimensions. In one embodiment of the present invention which is not meant to limit the scope of the present invention, plywood 100 is manufactured from coconut palm strips laminated using cold press techniques that are known in the field. Coconut palm strips are obtained from the outer, denser portion of a coconut palm. These strips, which can be up to 3 inches wide, are dried to an appropriate moisture content, and are then arranging as square strips or rectangular strips with adjoining adjacent long ends in a cold press with an adhesive for laminating core 110. In one embodiment of the present invention, which is not meant to limit the scope of the present invention, the strips are dried to a moisture content of 6-8%. Suitable adhesives are known in the field, and include, for example, Multibond 2000 (Franklin International, Columbus, Ohio).

Veneers 121 and 131 are sliced from the coconut palm trunk and dried further than the core. Thus, for example, the veneers are dried to approximately 4%. The portions forming surfaces 101 and 107 are sanded, and arranged in a cold press with core 110 and pressed for approximately 3 hours. The adhesive of the pressed laminated palm is then dried for a number of days, and lumber product 100 is then milled and finished.

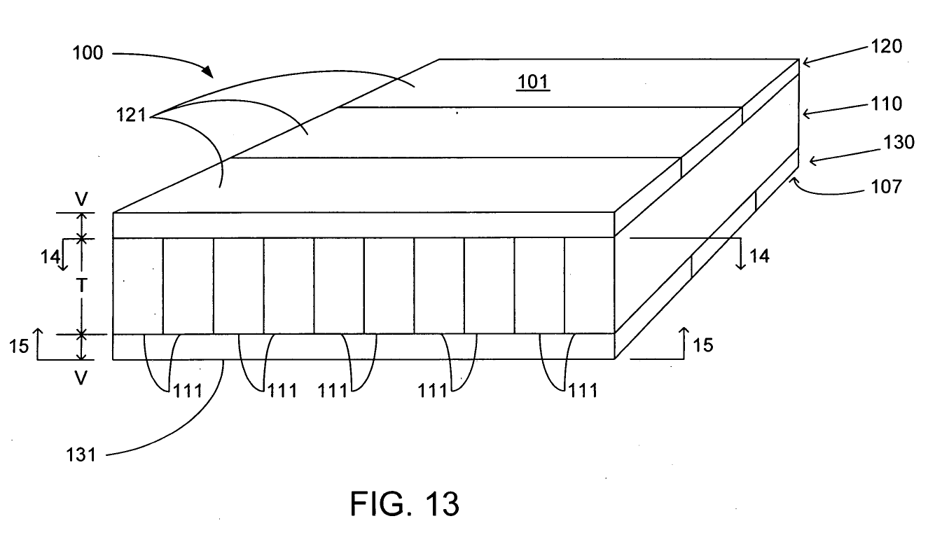

FIGS. 13-15 depict another embodiment laminated palm product 100, which may be generally similar to the embodiment illustrated in FIGS. 1-3, except as further detailed below. Where possible, similar elements are identified with identical reference numerals in the depiction of the embodiments of FIGS. 1-3 and FIGS. 13-15.

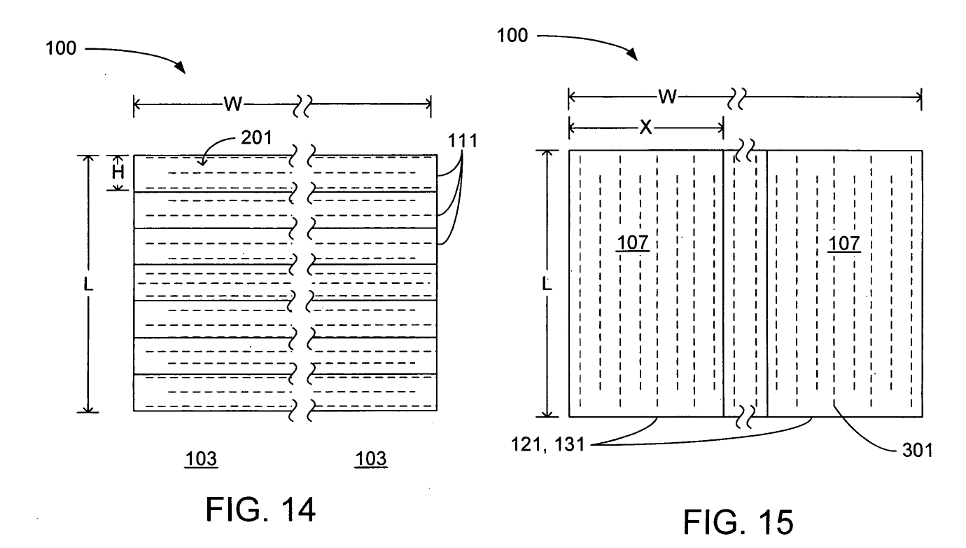

FIG. 13 as a perspective view showing the top and sides of product 100, FIG. 14 as a sectional top view 14-14 showing a view of the core of the embodiment of FIG. 13, and in FIG. 15 as a bottom view 15-15 showing a view of the first and second veneers the embodiment of FIG. 13. Product 100 of FIGS. 13-15 has grains 201 of strips 111 of core 110 that are laminated perpendicular to grains 301 of veneers 121 and 131. This “cross-lamination” relative to the grains provides additional structural stability to product 100.

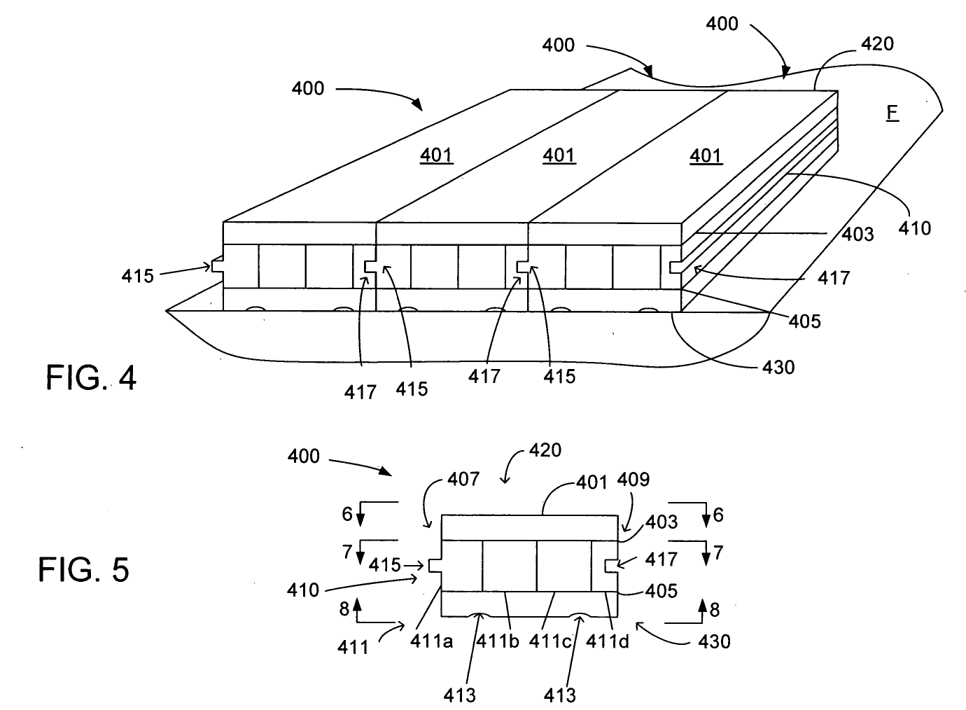

A second embodiment of a lumber product according to the present invention is a flooring plank 400 having a core 410, a first veneer 420, and a second veneer 430, as shown in FIG. 4 as a perspective view of the top and sides of the plank, and in FIG. 5 as a side view of the plank. Each plank 400 has an elongated, generally rectangular shape including a back surface 405 of core 410, a front, flooring surface 401 of veneer 420, a first side 407 and a second side 409. Core 410 has a surface 403 opposite back surface 405 that is laminated to veneer 420, and back surface 405 that is laminated to veneer 430, which has one or more kerfs 413 that run along the length of the plank, and that aids in the stability of plank 400 as well as to the attachment of the plank to a sub-floor F.

A plurality of planks 400 can be arranged to cover a floor F with the first side 407 of one plank abutting the second side 409 of the adjacent plank. Core 410 includes several laminated strips 411 that each extend from back surface 405 to surface 403. For illustrative purposes not meant to limit the scope of the present invention, core 410 is shown as being formed from 4 strips of square cross section 411a, 411b, 411c, and 411d, where strip 411a of one plank abuts strip 411d of an adjacent plank.

In one embodiment of the present invention, sides 407 and 409 have interlocking shapes to aid in the placement and location of planks 400. In the embodiment of FIG. 5, for example, a tongue and groove arrangement is used, where strip 411a forming first side 407 has a tongue 415 and strip 411d forming second side 409 has a groove 417.

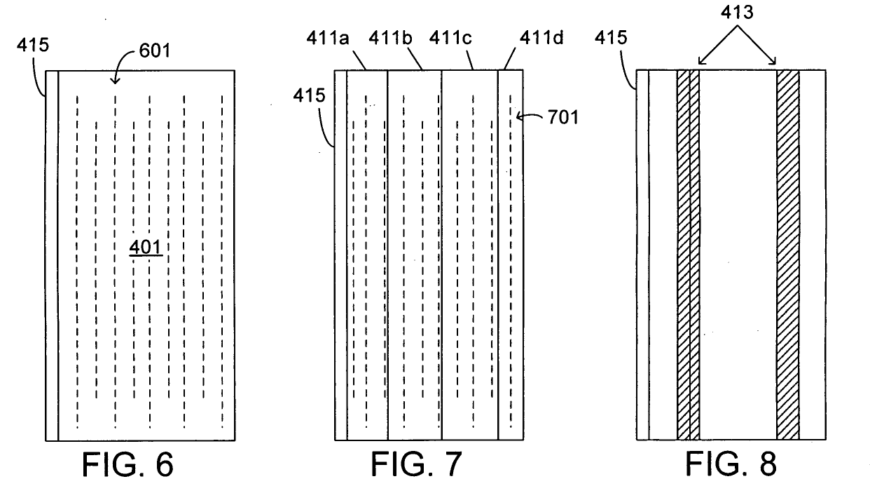

Plank 400 is shown in further detail in the various views in FIGS. 6-7, where FIG. 6 is a top view 6-6, and FIG. 7 is a top sectional top view 7-7, and FIG. 8 is a bottom view 8-8. As is shown in FIG. 6, the top surface 401 has a grain 601 that runs the length of the flooring plank. The sectional top view of FIG. 7 shows each strip 411 having a grain 701 that is also parallel to grain 601. The bottom view of FIG. 8 shows kerfs 413 running the length of plank 400. Preferably kerfs 413 are in veneer 430, as shown in FIG. 5.

In one embodiment of the present invention, each plank 400 has a length of approximately 9 inches, and the combined thickness of core 410 and veneer 420 is approximately three-quarters of an inch.

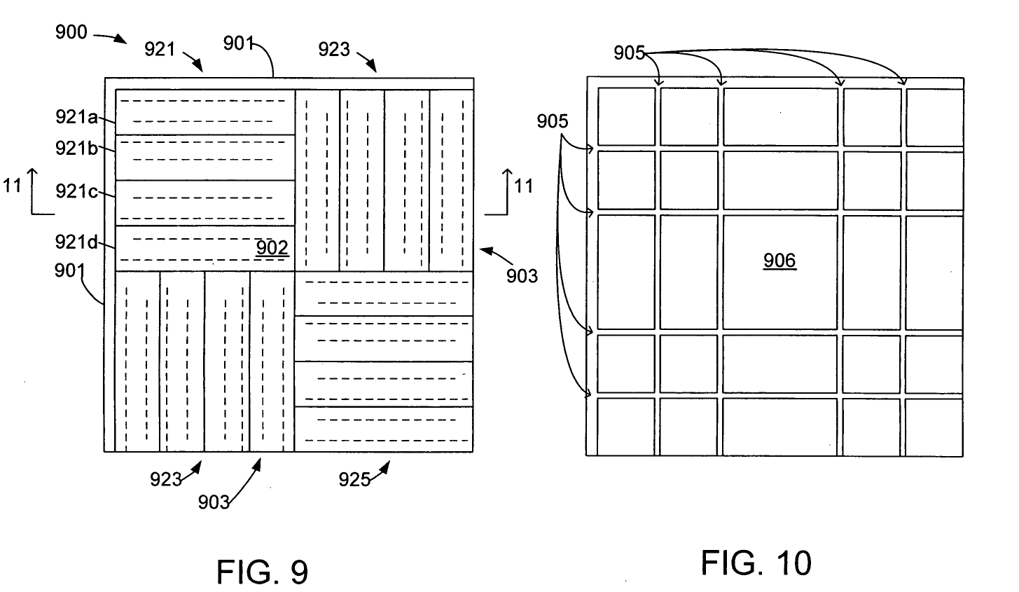

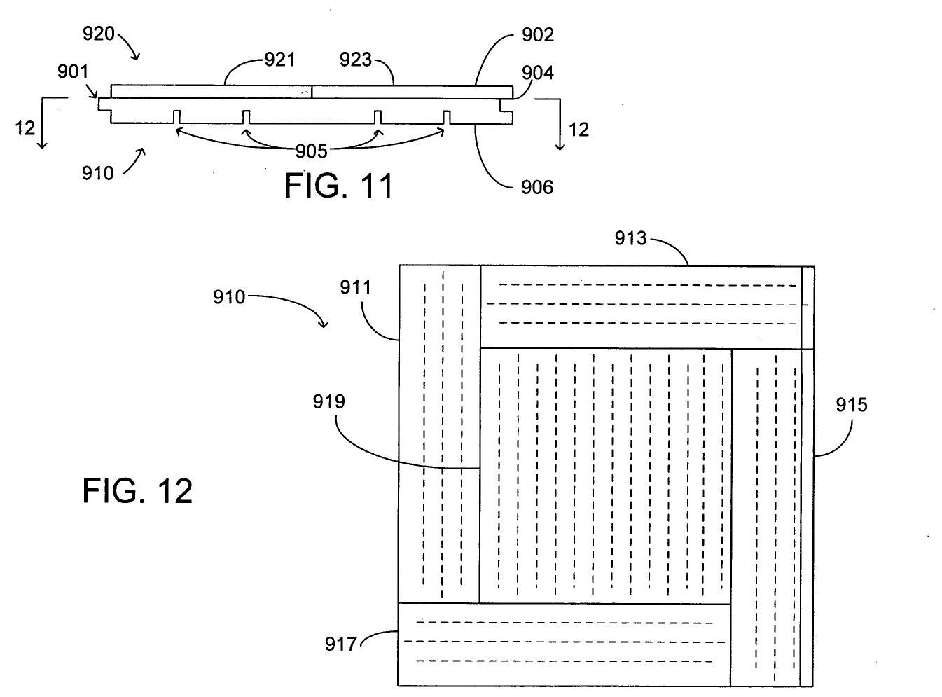

FIG. 9 is a top view of a third embodiment of a lumber product of the present invention showing one parquet square 900. Parquet square 900 is shown in more detail as the bottom view of FIG. 10, the sectional side view of FIG. 11, and the sectional top view of FIG. 12. Square 900 has a parquet surface 902, as shown in FIG. 9, and a back surface 906, as shown in FIG. 10, for mounting the square to the floor, and tongues 901 and grooves 903 for mating with other squares.

More specifically, square 900 includes a core 910 and a veneer 920. Core 910 has a generally square shape formed by edges 912, 914, 916, and 919, and extends from back surface 906 having several kerfs 905 to an upper surface 904. Edges 912 and 914 each include a tongue 901, and edges 916 and 918 each include a groove 903. As shown in FIG. 12, core 910 is formed from five pieces of coconut palm lumber—four elongated strips 911, 913, 915, and 917—that each extend through the thickness of the core and are arranged about a square piece 919.

The grain for the pieces forming core 910 are shown as dashed lines in FIG. 12. Each strip 911, 913, 915, and 917 is aligned with and forms a substantial portion of a corresponding edge 912, 914, 916, and 919, respectively. The grain of core 910 is thus aligned through the thickness of the core and generally follows the outer circumference of the core.

In general, more than five pieces may be used to form core 910, with the pieces arranged so that the grain is generally along the direction of the core's edge. This arrangement of grain provides improved structural stability over cores having parallel grain or over cores having grains that run in several directions through the thickness of the core.

In the illustrated embodiment, veneer 920 is formed from four veneer squares each having four pieces and is attached to upper surface 904. Specifically, veneer 920 includes veneer square 921, 923, 925, and 927. FIG. 9 shows grain of each veneer 921, 923, 925, and 927 as dashed lines. The parquet pattern of the third embodiment is for illustrative purposes, as many other parquet patterns are well known in the art. Each veneer 921, 923, 925, and 927 is further comprised of four strips, for example veneer 921 includes strips 921a, 921b, 921c, and 921d, each having the same shape and mutually aligned grains.

In one embodiment of the present invention, each square 900 has a side of approximately one foot. The combined thickness of core 910 and veneer 920 is preferably between approximately ⅜ and ¾ inch.

Parquet square 900 can be manufactured from coconut palm lumber having dimensions disclosed herein and using cold press techniques that are known in the field. As an example of a manufacturing technique that is not meant to limit the scope of the present invention, veneers 921, 923, 925, and 927 are first formed by cold pressing coconut palm strips that have been kiln dried. Veneers 921, 923, 925, and 927, strips 911, 913, 915, and 917 and square piece 919 are then stacked as nine separate pieces into a cold press form, along with an adhesive, to maintain the shape of the separate elements during pressing. The adhesive of the pressed laminated palm material is then dried for an additional day, surface 902 is sanded and finished, kerfs 905 are cut, and tongue 901 and groove 903 are formed.

It is to be understood that this invention is not limited to those embodiments and modifications described in the specification. Modifications and variations can be made by one skilled in the art without departing from the sprit and scope of the invention. For example, the core may contain more than one layer of strips, and the strips may be formed from individual pieces of palm or from laminated or joined pieces of palm. Moreover, any one or more features of any embodiment of the invention may be combined with any one or more other features of any other embodiment of the invention, without departing from the scope of the invention.

What is claimed is:

1. A palm product comprising:
a core having a pair of opposing major surfaces including a first surface and a second surface, said core including a plurality of elongate strips of coconut palm each having a cross-section and having grains aligned with the length of said strip; and
a veneer on said first surface.

2. The palm product of claim 1, wherein said veneer has grains and wherein said grains of said veneer are approximately parallel to said grains of said plurality of elongate strips.

3. The palm product of claim 1, wherein said veneer has grains and wherein said grains of said veneer are approximately perpendicular to said grains of said plurality of elongate strips.

4. The palm product of claim 1, wherein said core is a single-ply core, wherein said veneer is a first veneer, and further comprising a second veneer on said second surface.

5. The palm product of claim 4, wherein said second veneer has grains and wherein said grains of said second veneer are approximately parallel to said grains of said plurality of elongate strips.

6. The palm product of claim 4, wherein said second veneer has grains and wherein said grains of said second veneer are approximately perpendicular to said grains of said plurality of elongate strips.

7. The palm product of claim 1, wherein said core is a double-ply core.

8. The palm product of claim 1, wherein said cross section is a rectangular.

9. The palm product of claim 8, wherein said cross section is a square.

10. The palm product of claim 8, wherein said plurality of elongate strips are joined using straight joints.

11. The palm product of claim 1, wherein each of said plurality of elongate strips is a single piece of coconut palm.

12. The palm product of claim 1, wherein each of said plurality of elongate strips is two or more pieces of joined coconut palm.

13. The palm product of claim 1, wherein said second surface has at least one kerf.

14. The palm product of claim 4, wherein each of said major pair of opposing surfaces is rectangular, wherein said core has two pairs of opposing minor surfaces between said major pair of opposing surfaces including a first minor pair of opposing surfaces and a second minor pair of opposing surfaces, and wherein said first minor pair of opposing surfaces includes a first surface having a tongue of a tongue-and-groove joint and a second surface has a groove matching said tongue of said first surface, such that multiple palm products can be joined using a tongue-and-groove joint.

15. The palm product of claim 14, wherein said second veneer has at least one kerf.

16. The palm product of claim 14, wherein said first veneer and said second veneer is a coconut palm veneer.

17. The palm product of claim 14, wherein at least one of said first veneer and said second veneer is single piece of coconut palm.

18. The palm product of claim 14, and wherein said second minor pair of opposing surfaces includes a third surface having a tongue of a tongue-and-groove joint and a fourth surface has a groove matching said tongue of said first surface, such that multiple palm products can be joined in a two-dimensional array using a tongue-and-groove joint.

19. A laminated palm product comprising:
a core having a pair of opposing major surfaces including a first surface and a second surface, said core including a plurality of elongate strips of coconut palm each having a cross-section and having grains aligned with the length of said strip;
a first veneer of coconut palm on said first surface; and
a second veneer of coconut palm on said second surface.

20. The palm product of claim 19, wherein said first veneer has grains, wherein said second veneer has grains, and wherein said grains of said first veneer and said second veneer are approximately parallel to said grains of said plurality of elongate strips.

21. The palm product of claim 19, wherein said first veneer has grains, wherein said second veneer has grains, and wherein said grains of said first veneer and said second veneer are approximately perpendicular to said grains of said plurality of elongate strips.

22. The palm product of claim 19, wherein said cross section is a rectangular.

23. The palm product of claim 22, wherein said cross section is a square.

24. The palm product of claim 19, wherein said plurality of elongate strips are joined using straight joints.

25. The palm product of claim 19, wherein each of said plurality of elongate strips is a single piece of coconut palm.

26. The palm product of claim 19, wherein each of said plurality of elongate strips is two or more pieces of joined coconut palm.

27. The palm product of claim 17, wherein said second veneer includes at least one kerf.

28. The palm product of claim 26, wherein each of said major pair of opposing surfaces is rectangular, wherein said core has two pairs of opposing minor surfaces between said major pair of opposing surfaces including a first minor pair of opposing surfaces and a second minor pair of opposing surfaces, and wherein said first minor pair of opposing surfaces includes a first surface having a tongue of a tongue-and-groove joint and a second surface has a groove matching said tongue of said first surface, such that multiple palm products can be joined using a tongue-and-groove joint.

29. The palm product of claim 28, wherein said first veneer or said second veneer is single piece of coconut palm.

30. The palm product of claim 28, and wherein said second minor pair of opposing surfaces includes a third surface having a tongue of a tongue-and-groove joint and a fourth surface has a groove matching said tongue of said first surface, such that multiple palm products can be joined in a two-dimensional array using a tongue-and-groove joint.

31. The palm product of claim 28, wherein said first veneer or said second veneer is coconut palm.

32. A palm product comprising:
a core having a pair of opposing major surfaces including a first surface and a second surface and having a substantially square perimeter defining four edges, where said core is a single-ply core including a plurality of elongate strips each having a cross-section and a grain, where said grain is parallel along at least one half of each of said four edges; and
a veneer substantially covering one pair of said opposing surfaces.

33. The palm product of claim 32, wherein said core includes at least one kerf.

34. The palm product of claim 32, wherein said core includes a central square core and four rectangular cores each extending from said central square core to said perimeter.

35. The palm product of claim 32, wherein said core is coconut palm.

36. The palm product of claim 32, wherein said veneer is coconut palm.

37. The palm product of claim 36, wherein said veneer is a parquet veneer.

38. The palm product of claim 32, and wherein said four edges are two pairs of opposing edges, and wherein each of said two pairs of opposing edges includes either a tongue or a groove.
